(19) United States
(12) Patent Application Publication
(10) Pub. No.: US 2020/0142397 A1
(43) Pub. Date: May 7, 2020

(54) MOVABLE ROBOT

(71) Applicant: LG ELECTRONICS INC., Seoul (KR)

(72) Inventors: Sunryang KIM, Seoul (KR); Anna KIM, Seoul (KR); Yoonsik KIM, Seoul (KR); Joohan KIM, Seoul (KR); Keunsik NO, Seoul (KR); Hyeri PARK, Seoul (KR); Jaecheon SA, Seoul (KR); Kangsoo SHIN, Seoul (KR); Woojin JEONG, Seoul (KR); Woong JEONG, Seoul (KR)

(21) Appl. No.: 16/674,349

(22) Filed: Nov. 5, 2019

(30) Foreign Application Priority Data
Nov. 7, 2018 (KR) 10-2018-0136193

(51) Int. Cl. G05D 1/00; G05D 1/02

(52) U.S. Cl. CPC G05D 1/0016; B62B 5/0033; G05D 2201/0216; G05D 1/0276

(57) ABSTRACT

A robot may include: a frame module constituting a main body; a driver module for powering a wheel rotatably coupled to the frame module; a position detector for detecting a position of a user terminal device; and a main controller configured for: controlling the driver module to operate in a user following mode based on a position of the user terminal device; and controlling the driver module to operate in a driving-power supporting mode based on whether a manual driving detector detects a user touch. The frame module may by coupled to a basket so that the robot may provide a transport service as a shopping cart, such as driving along a user's travel path in a following mode or supporting a user-supplied driving power when a user manually controls the cart.

### CROSS-REFERENCE TO RELATED APPLICATION

This application claims priority under 35 U.S.C. § 119 to Korean Application No. 10-2018-0136193 filed on Nov. 7, 2018, whose entire disclosure is hereby incorporated by reference.

### BACKGROUND

### 1. Field

The present disclosure relates to a movable robot.

### 2. Background

Robots may perform various functions. For example, a robot may have an industrial use, such as factory automation. A robot may perform other functions, such as a medical robot, an aerospace robot, or a robot that may be used to perform a routine function in a user's daily life. Accordingly, robots capable of providing various services have been recently developed. For example, robots may provide specific services (e.g., functions related to shopping, transporting, serving, talking, cleaning, etc.) in response to a user's command.

For example, Korean Patent Application Publication No. 2010-98056 describes a cart robot driving system in which a cart robot is capable of automatic driving. The cart robot described in this reference may include a basket to receive goods therein and that may be moved by a user application of a manual force to push or drag the basket, a plate defining a bottom of the basket and on which the goods are received, and a lifting or lowering (or elevator) unit that lifts or lowers the plate to vertically move goods received inside the basket. The above reference is incorporated by reference herein where appropriate for appropriate teachings of additional or alternative details, features and/or technical background.

### BRIEF DESCRIPTION OF THE DRAWINGS

The embodiments will be described in detail with reference to the following drawings in which like reference numerals refer to like elements wherein:

FIG. 1 is a perspective view of a movable robot having a shopping cart function according to an embodiment of the present disclosure.

FIG. 2 is a block diagram showing in detail components of the movable robot shown in FIG. 1.

FIG. 3 is a perspective view of a movable robot in a state in which a basket module of FIG. 1 is removed from a frame module.

FIG. 4 is a block diagram showing in detail a configuration of a position detector shown in FIG. 1 to FIG. 3.

FIG. 5 is a block diagram showing in detail a configuration of a driver module shown in FIG. 1 to FIG. 3.

FIG. 6 is a block diagram showing in detail a configuration of a main controller shown in FIG. 1 to FIG. 3.

FIG. 7 is a diagram for explaining a user location identification method using a user travel-path generator shown in FIG. 6.

FIG. 8 is a diagram for explaining a method of detecting a distance between a user and a robot using a user travel-path generator shown in FIG. 6.

FIG. 9 is a diagram illustrating a user-following support method using a robot travel-path generator shown in FIG. 6.

### DETAILED DESCRIPTION

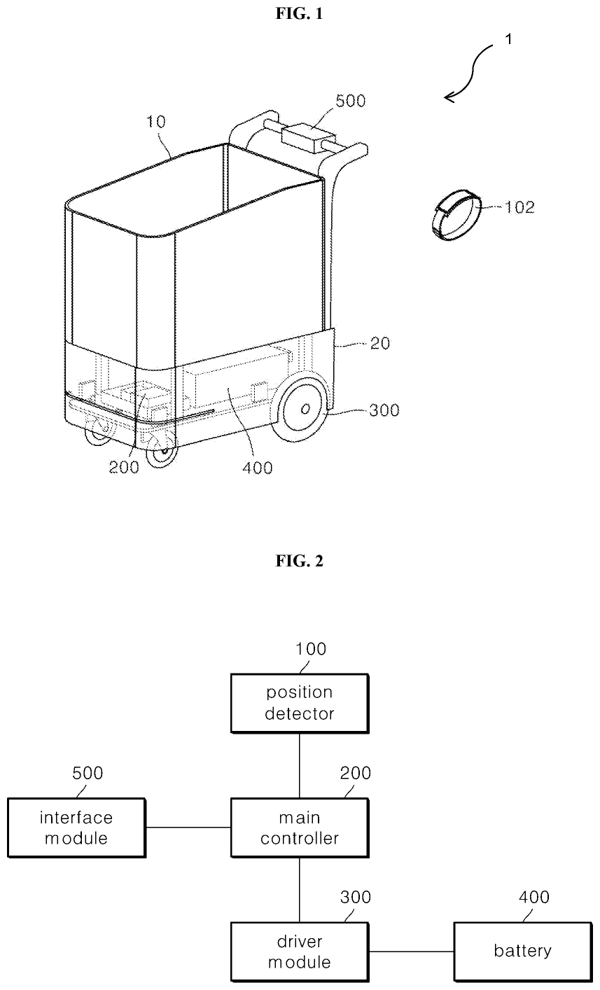

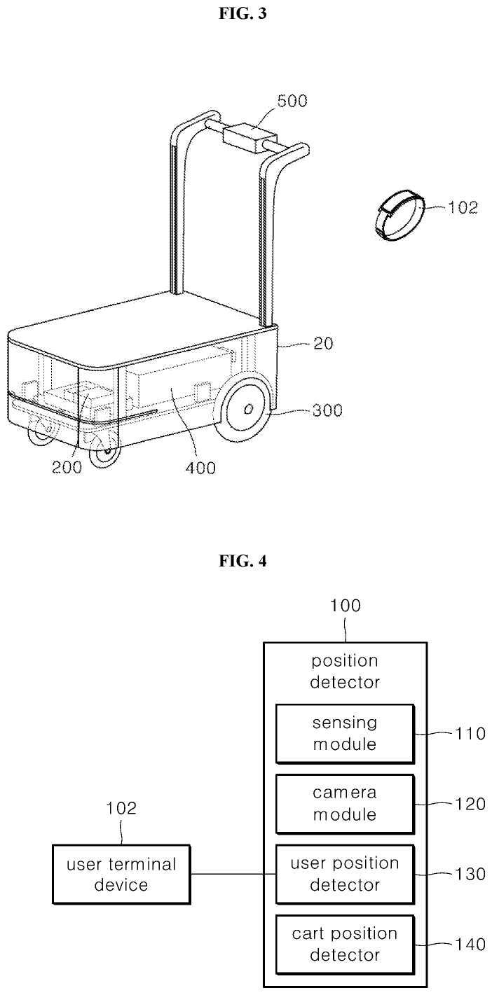

Hereinafter, exemplary embodiments of a movable robot according to the present disclosure will be described in detail with reference to the accompanying drawings. For example, FIG. 1 is a perspective view of a movable robot 1 having a shopping cart function according to one example; FIG. 2 is a block diagram showing examples of components that may be included in the movable robot 1; and FIG. 3 is a perspective view of the movable robot 1 that does not include a basket module (or basket) 10.

A movable robot 1 in accordance with aspects of the present disclosure may be configured to provide various functions, such as to function as a shopping cart having a basket to receive items or a push cart having a planar carrying surface to receive items. Referring to FIG. 1 to FIG. 3, the movable robot 1 in one example may include a frame module (or frame) 20 constituting a main body of the robot 1, a position detector (or first sensor) 100 that detects a position of a user terminal device (or user device) 102, a driver module (or motor) 300 that drives a wheel rotatably coupled to the frame module 20, a main controller 200 that sets and switches a driving mode for the robot 1, and a battery 400 that stores and supplies power to the driver module 300 and other components of the movable robot 1. The user terminal device 102 may be wearable device worn by a user, such as a smart watch or smart glasses, or may be a portable device, such as a smart phone, tablet, an internet of things device worn by the user, laptop computer, etc.

A basket module (or basket) 10 may be removably coupled to a top, a front, or other portion of the frame module 20. A handle frame that allows a user to grab the frame module 20, such as to control a driving direction of the robot 1, may be positioned on a rear part or other portion of the frame module 20. A manual driving detector, such as a gyroscope or other force sensor to detect a user force on the handle frame, may be included as a component of the driver module 300 and may be positioned on the handle frame of the frame module 20.

Further, an interface device (or display) 500 may be positioned on the handle frame. The interface device 500 may by a display, lights, etc. to present visual information identifying a mode and/or status of the robot 1, such as identifying a position detection state of the user terminal device 102 associated with the position detector 100, a setting and changing state of the driving mode by the main controller 200, an amount of remaining charge stored by the battery 400, a driving state of the driver module 300, etc. The user interface device 500 may further include a button, touch sensor, etc. to receive a user input, such as an instruction to perform or change a function.

The driver module 300 may include a motor (described below) to drive a rotation of a wheel coupled to the frame module 20 and may selectively supply electrical power to the motor to control a driving force of the wheel-rotating motor. For example, the driver module 300 may supply electrical power to the at least one wheel-rotating motor under control of the main controller 200 when the main controller 200 activates a user following mode in which movable robot 1 moves to a location associated with a detected user terminal 102.

On the other hand, when the main controller 200 activates a driving power support mode, the driver module 300 may detect a push force from the user applied to the manual driving detector on the handle bar of the frame module 20. Then, the driver module 300 may supply the electrical power to the at least one wheel-rotating motor for the at least one wheel coupled to the frame module 20 in response to the detection of the push force.

The position detector 100 may be mounted, for example, on the frame module 20, the driver module 300, or another portion of the robot 1, and may collect data and process the collected data to detect the position of the user terminal device 102. For example, the position detector 100 may determine a distance between the robot 1 and the user terminal device 102, and a direction from the robot 1 to the user terminal device 102. In particular, the position detector 100 may generate position coordinate information of the user terminal device 102 based on the distance information from the user terminal device 102 and the direction information thereof.

The main controller 200 may control the driver module 300 based the robot 1 being in one of the user following mode, driving-power supporting mode, or standby mode, which may be set by the user via the interface 500. Alternatively, the main controller 200 may activate the user following mode based on the distance information from the user terminal device 102 and the direction information thereof as detected by the position detector 100 to automatically control the driver module 300. For example, as described below, the main controller 200 may activate the user following mode when the robot 1 is positioned more than a threshold distance (e.g., 2 m) from the user terminal device 102 or when the robot 1 is positioned in a particular direction (e.g., behind a user's moving direction) with respect to the user terminal device 102. In another example, the main controller 200 may switch the operation mode of the driver module 300 to the driving-power supporting mode based on whether the manual driving detector detects the push force from the user to support the manual driving of the robot.

In the following discussions, the main controller 200, the user position detector 130, the cart position detector, the first motor controller 350, and the second motor controller 360 may be collectively referred to as a “controller” and may be implemented as a processor and/or circuitry that executes software to carry out the described functions.

In one implementation, the main controller 200 may determine whether the user terminal device 102 is located within or outside of a predefined neutral zone based on the distance information from the user terminal device 102 and the direction information thereof, as detected by the position detector 100. Upon determination that the user terminal device 102 is outside of the pre-defined neutral zone, the main controller 200 may control the driver module 300 to operate in the user following mode.

For example, when the driver module 300 operates in the user following mode, the main controller 200 may compare the position coordinate information of the user terminal device 102 received from the position detector 100 with the coordinate information of the position detector 100. The main controller 200 may monitor the position coordinate information of the user terminal device 102 in real time to generate movement path information of the user terminal device 102 based on change of the position coordinate of the user terminal device 102. Subsequently, the main controller 200 may compare the movement path information of the user terminal device 102 with the current position coordinate information of the position detector 100 to set the driving coordinate and the driving path in real time. The main controller 200 may control the driver module 300 such that the robot maintains a prescribed distance from the user terminal device 102 based on the set driving coordinate and the driving route.

In one example, the main controller 200 may control the driver module 300 to operate in the standby mode when it is determined that the user terminal device 102 is located in the neutral zone. When a user's touch (e.g., an input to interface device 500) is detected by the manual driving detector in the neutral zone, the main controller 200 may control the driver module 300 to operate in the driving-power supporting mode such that the driver module 300 may support the manual driving of the robot. When the manual driving detector detects the user's push force applied to the handle frame, the driving-power supporting mode of the driver module 300 is activated to supply the electrical power to the wheel-rotating motor for the wheel coupled to the frame module 20.

In another implementation, the main controller 200 may automatically activate one of the user following mode, the standby mode, or the driving-power supporting mode based on, for example, the direction information of the user terminal device 102 as detected by the position detector 100. For instance, the main controller 200 may automatically control the driver module 300 to operate in the user following mode when the user terminal device 102 is moved out of the neutral zone while being located in front of the position detector 100. On the other hand, the main controller 200 may automatically control the driver module 300 to operate in the standby mode when the user terminal device 102 is located laterally from the position detector 100. Furthermore, the main controller 200 may automatically control the driver module 300 to operate in the driving-power supporting mode when the user terminal device 102 is moved into the neutral zone while being located in a rear direction of the position detector 100 (e.g., in a direction of the handle bar of the frame module 20).

Continuing with FIGS. 1-3, the battery 400 may store power and may supply electrical power to one or more of the driver module 300, the position detector 100, or the main controller 200. For example, as previously described, the position detector 100 may receive electrical power to determine a location of the user terminal 102, the controller 200 may receive power to determine a mode for the robot 1, and a motor in the driver module 300 may selectively receive power to cause a movement of the robot 1 based on the location of the user terminal 102 and based on the mode set by the main controller 200.

FIG. 4 is a block diagram showing in detail a configuration of the position detector 100. Referring to FIG. 4, the position detector 100 may include, for example, a sensing module (or distance sensor) 110, a camera module (also referred to as a camera or direction sensor) 120, a user position detector (or user position processor) 130, and a cart position detector (or cart position processor) 140.

In one example, the sensing module 110 may recognize the user terminal device 102 and may detect distance information between the robot 1 and the user terminal device 102 and direction information regarding a location of the user terminal device 102 relative to the robot 1. In certain examples, the sensing module 110 may include at least one Ultra Wide Band (UWB)-based sensor such as a time-of-flight (ToF) sensor, a Lidar (light radar) sensor, a microcontroller or other circuitry and/or software that converts a sensing signal into a digital signal and generates distance and direction data, and a wired/wireless communication module, etc. For example, the sensing module 110 may emit a signal that is reflected by the user terminal device 102, and the sensing module 110 may determine a distance to the user terminal device 102 based on, for example, a delay and/or an intensity associated with the reflected signal.

The camera module 120 may capture image data, such as to photograph a region associated with the user terminal device 102 to detect direction information of the user terminal device 102. The camera module 120 may photograph the user terminal device 102 using an image sensor such as a charge-coupled device (CCD). The sensing module 110 may then detect the direction information of the user terminal device 102 based on position and direction comparison results between the photographed user terminal device 102 and the camera module 120. For example, the sensing module 110 may estimate a distance between the robot 1 and the user terminal device 102 based on a relative size of the user terminal device 102 in the captured image. In another example, the sensing module 110 may estimate a direction between the robot 1 and the user terminal device 102 by comparing a relative location of the user terminal device 102 in the captured image with other reference items captured in the image, such as portions of the robot, background objects, etc.

The user position detector 130 may be a processor or other circuitry that receives the distance and direction information of the user terminal device 102 (e.g., from the camera module 120) and generates the position coordinate information of the user terminal device 102. The generated position coordinate information of the user terminal device 102 may be compared with reference coordinate information of the position detector 100 provided by the cart position detector 140 (e.g., information identifying a location of the robot 1) to generate comparison coordinate information. In one example, the cart position detector 140 may be a processor or other circuitry that generates the reference coordinate information based on a distance between the robot 1 and the user terminal device 102 and the direction therebetween.

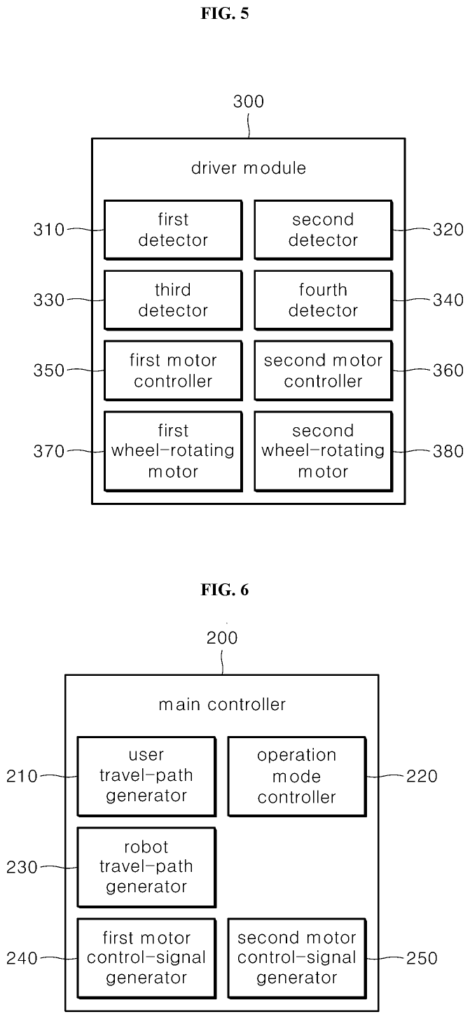

FIG. 5 is a block diagram showing a configuration of the driver module 300 in one implementation. Referring to FIG. 5, the driver module 300 may include a plurality of manual driving detectors (or second sensors) 310 to 340, one or more wheel-rotating motors (or motors) 370 and 380, and one or more motor controllers 350 and 360. It should be appreciated that the driver module 300 may include different quantities of the detectors 310-340, the motors 370, 380, and/or the motor controllers 350, 360.

Each of the plurality of manual driving detectors 310 to 340 may detect a user's touch and a user application of a push force. The manual driving detectors 310 to 340 may be provided at different positions on the robot 1. In one implementation, front and rear sensing signals corresponding to the detected push force may be generated by the plurality of manual driving detectors 310 to 340. The manual driving detectors 310 to 340 may include, for example, an inertia sensor, such as a gyroscope to identify a magnitude and direction or an applied user force. In another example, the manual driving detectors 310 to 340 may include a touch sensor to sense a user contact.

For example, the first and second detectors 310 and 320 may be positioned at front and rear faces of a right handle frame, respectively. In this configuration, the first detector 310 may detect the user's push force in a rear direction, and the second detector 320 may detect the push force of the user in a front direction. Similarly, the third and fourth detectors 330 and 340 may be positioned in front and rear faces of a left handle frame, respectively. In this configuration, the third detector 330 may detect the user's push force in a rear direction, and the fourth detector 340 may detect a push force of the user in a front direction.

In this handle configuration, the first to fourth detectors 310 to 340 may combine to detect the front and rear directional touch and push force of the user at the left and right handle frames. The front and rear sensing signal corresponding to the detected push forces may be generated by the first to fourth detectors 310 to 340, respectively. In certain examples, the forces detected by the first to fourth detectors 310 to 340 may be evaluated to determine diagonally applied forces, such as to detect when a user pushes one of the right or left handle frames and pulls the other one of the right or left handle frames.

Each of the first and second wheel-rotating motors 370 and 380 may include an electric motor and a power transmission shaft, thereby supplying a driving force to each wheel shaft coupled to the frame module 20. When the driver module 300 operates in the driving-power supporting mode (e.g., to augment a user-supplied force) under control of the main controller 200, the first and second motor controllers 350 and 360 may, respectively, control driving forces of the first and second wheel-rotating motors 370 and 380 based on the front and rear directional touch and push forces of the user as sensed by the first to fourth detectors 310 to 340. For example, one or more of the motors 370 and 380 may be activated to provide a driving force to rotate associated wheels in a direction associated with a user force, such as to rotate wheels to move the robot 1 in a direction associated with the user force or other rotate the wheels in opposite direction to turn the robot 1 when the user force is applied in opposite surfaces of the left and right portions of the handle. Furthermore, the amount of driving force applied by the motors 370 and 380 may be determined based on the push force, such as to provide driving force such that a total force applied to the robot 1 (e.g., a sum of the user force and torque provided by rotation of the driving wheel) causes the robot 1 to travel a particular distance and/or at a particular velocity. In another implementation, the amount of driving force applied by the motors 370 and 380 may be correspond to a multiple of the detected user force, such that a stronger user force results in a stronger driving force applied by the motors 370 and 380.

In another example, when the driver module 300 operates in the user following mode (e.g., to move toward a determined location of the user corresponding to a location of the user terminal device 102) under control of the main controller 200, the first and second motor controllers 350 and 360 may control the driving force of each of the first and second wheel-rotating motors 370 and 380 in response to a control signal from the main controller 200. For example, control signal may direct the first and second wheel-rotating motors 370 and 380 to provide driving forces to the wheels such that the robot 1 moves in a direction based on a location of the user terminal device 102, such as to move toward the user terminal device 102 and to maintain a prescribed separation from the user terminal device 102.

FIG. 6 is a block diagram showing a configuration of the main controller 200 in one implementation. The main controller 200, as illustrated in FIG. 6, may include at least one component of a user travel-path generator 210, an operation mode controller 220, a robot travel-path generator 230, and one or more motor control-signal generator 240 and 250. Using those components, the main controller 200 may control the driver module 300 based on a current operation mode of the robot, such as to selectively the driver module 300 based on whether the robot is in the user-following mode or a driving-power supporting mode, as set from the user via the interface 500 and/or as set based on a detected location of the robot and the user, as previously described.

In certain examples, the user travel-path generator 210 of the main controller 200 may receive the position coordinate information of the user terminal device 102 from the position detector 100 and the position coordinate information of the position detector 100 itself. For example, the user travel-path generator 210 of the main controller 200 may receive the types of position coordinate information in real time. Then, the user travel-path generator 210 may compare the position coordinate information of the user terminal device 102 with the coordinate information of the position detector 100 itself to generate the movement path information of the user terminal device 102 based on the operation mode of the robot 1.

The operation mode controller 220 may automatically select one of movement modes of the robot (e.g., one of the user following mode, the standby mode, or the driving-power supporting mode) based on the result of comparing the position coordinate information of the user terminal device 102 with the coordinate information of the position detector 100 itself and may transmit the selected operation mode to the driver module 300. The mode operation selection by the operation mode controller 220 will be described in more detail with reference to the accompanying drawings. While the present discussion describes the user following mode, the standby mode, or and the driving-power supporting mode, it should be appreciated that other movement modes may be implemented, such as a user avoidance mode that includes moving away from a position of a user, an obstacle avoidance mode that moves away from a position of an obstacle, or a robot avoidance mode that moves away from a position of another robot.

When the operation mode controller 220 selects the user following mode, the robot travel-path generator 230 may compare the movement path information of the user terminal device 102 with current position coordinate information of the position detector 100 and may then generate a desired driving coordinates and a desired driving route in real time based on the comparison result.

The plurality of motor control-signal generators 240, and 250 may include the first and second motor control-signal generators 240 and 250. Each of the first and second motor control-signal generators 240 and 250 may generate control signals of the first and second motor controllers 350 and 360 of the driver module 300 based on the driving coordinate and the driving route generated by the robot travel-path generator 230 such that the robot travels while maintaining a pre-set distance from the user terminal device 102.

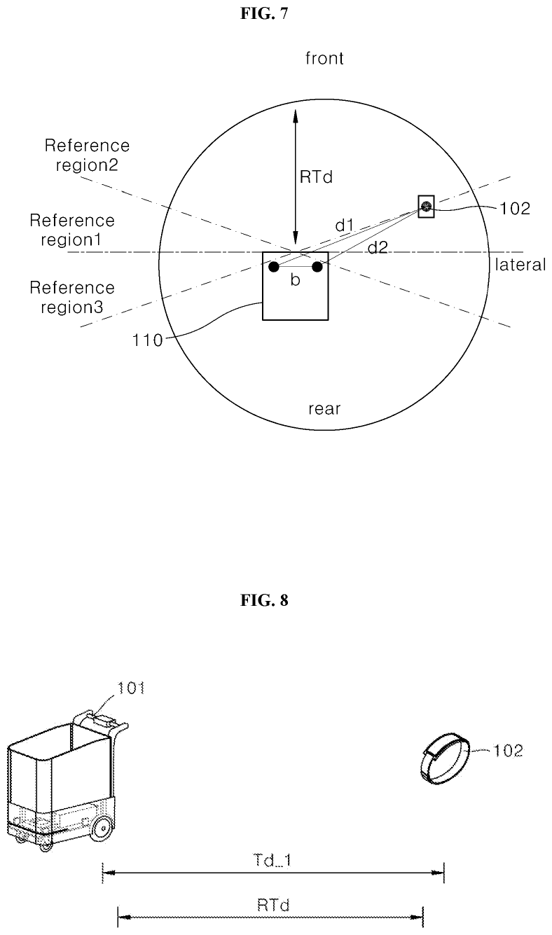

FIG. 7 is a diagram for explaining a user location identification method using a user travel-path generator 210, and FIG. 8 is a diagram for explaining a method of detecting a distance between a user and a robot 1 using the user travel-path generator 210. Referring to FIG. 7 and FIG. 8, the operation mode controller 220 of the main controller 200 may determine whether the user terminal device 102 is located outside the neutral zone RTd based on the result of comparing the position coordinate information of the user terminal device 102 and the position coordinate information of the position detector 100 itself. When the user terminal device 102 is located outside the pre-set neutral zone RTd, the operation mode controller 220 may automatically control the driver module 300 to operate in the user following mode in which the robot 1 moves toward the user.

Further, when the user terminal device 102 is located within the neutral zone RTd, the operation mode controller 220 of the main controller 200 may automatically control the driver module 300 to operate in the standby mode. For example, the robot 1 may wait to move from a current location. Then, when the user touch is detected by the manual driving detector 310 to 340 while the user terminal device 102 is determined to be located within the neutral zone RTd, the operation mode controller 220 of the main controller 200 may automatically control the driver module 300 to operate in the driving-power supporting mode to support the manual driving of the driver module 300 based on a user-supplied force. As previously described, when the driver module 300 operates in the driving-power supporting mode, the main controller 200 may detect the user's push force applied to the manual driving detector 310 to 340 and control the driver module 300 to power the wheel-rotating motor for the wheels coupled to the frame module 20 based on the detected amount and/or direction of the user force.

In one example, the operation mode controller 220 of the main controller 200 may check one of a plurality of reference regions (reference regions 1 to 3) in which the user terminal device 102 is located based on the result of comparing the position coordinate information of the user terminal device 102 with the coordinate information of the position detector 100 itself. Based on the check result, current location information about whether the user terminal device 102 is located in front of or rear of the robot 1 or laterally to the robot 1 may be determined. As used herein, “rear” may refer to a portion of the robot 1 wherein a handle to receive a user force is positioned, “front” may refer to a portion of the robot opposite to the handle.

In one example, when the user terminal device 102 moves out of the neutral zone while being in front of the position detector 100, the operation mode controller 220 may automatically control the driver module 300 to operate in the user following mode. In another example, when the user terminal device 102 is located in the neutral zone while being located laterally to the position detector 100, the operation mode controller 220 may automatically control the driver module 300 to operate in the standby mode. In still another example, when the user terminal device 102 moves into the neutral zone while being in rear of the position detector 100, the operation mode controller 220 may automatically control the driver module 300 to operate in the driving-power supporting mode.

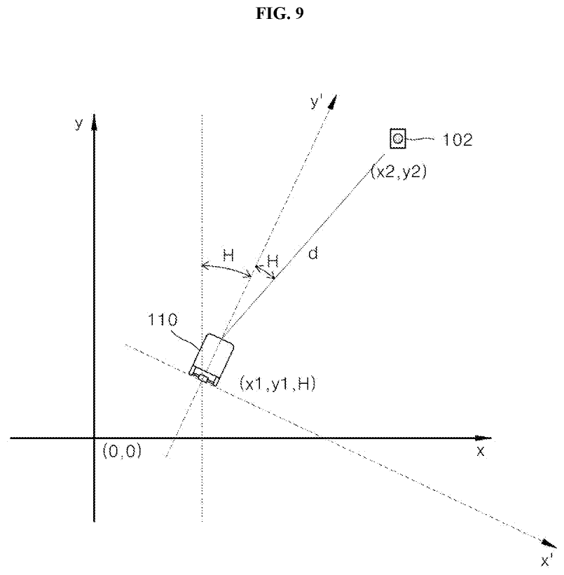

FIG. 9 is a diagram illustrating a user-following support method using a robot travel-path generator 230. Referring to FIG. 9, the user travel-path generator 210 may receive the position coordinate information (x2, y2) of the user terminal device 102 and the coordinate information (x1, y1, H) of the position detector 100 itself from the position detector 100, such as in real time. Then, the user travel-path generator 210 may compare the position coordinate information of the user terminal device 102 with the coordinate information of the position detector 100 itself to generate a omnidirectional positioning (y′), a positioning angle (H, x′) and a movement path information of the user terminal device 102.

Therefore, when the operation mode controller 220 controls the driver module 300 to operate in the following mode, the robot travel-path generator 230 may compare the movement path information (x2, y2, d) of the user terminal device 102 with the current position coordinate information (x1, y1, H) of the position detector 100 and then may set the driving coordinate and the driving route in real time based on the comparison result. When the driving route is set, the first and second motor control-signal generators 240 and 250 may control the first and second motor controllers 350 and 360 of the driver module 300, respectively such that the vehicle may drive while maintaining the pre-set distance d from the user terminal device 102 along the driving coordinate and the driving route set by the robot travel-path generator 230.

The movable robot having a shopping cart function according to the present disclosure may provide a transportation service as a shopping cart, and may travel along a user's path in the following mode or may support the driving power in the manual driving mode by the user. Thus, the movable robot having a shopping cart function according to the present disclosure may have increased utilization compared to conventional transportation equipment that provides only a transport service.

Further, the movable robot having a shopping cart function according to the present disclosure may automatically detect in real time whether the user terminal device 102 is within a preset neutral zone and may automatically control the driver module 300 to operate in in one of the user following modes, standby mode, and driving-power supporting mode based on the detection result. Thus, the movable robot having a shopping cart function according to the present disclosure may have expanded fields of applications and improve a quality of service.

Further, the movable robot having a shopping cart function according to the present disclosure may automatically control the driver module 300 to operate in in one of the user following modes, standby mode, and driving-power supporting mode based on the user's position and direction. Thus, the user's convenience and satisfaction may be further improved.

Further, the movable robot having a shopping cart function according to the present disclosure may the function as a shopping cart and may have other loading boxes and luggage packaging members other than a basket in an attached or detached manner. This may allow the utilization of the movable robot as a following cart such as a logistics cart.

Further, the movable robot having a shopping cart function according to the present disclosure may use a low-cost sensor such as UWB (Ultra Wide Band)-based ToF sensor and Lidar sensor to selectively operate the driver module in the following mode, standby mode, and driving-power supporting mode. Thus, a production cost of the movable robot may be lowered.

One aspect of the present disclosure provides a movable robot that provides a transport service as a shopping cart and of driving along a user's travel path in a following mode, or supporting a driving power when a user manually drives the cart.

Further, another aspect of the present disclosure provides a movable robot that detects whether a user with a terminal module is within a predetermined neutral zone, and of automatically switching to one of a user following mode, a standby mode, and a driving power support mode based on the detection result, and of operating in the switched mode.

Further, still another aspect of the present provides a movable robot capable of automatically switching to one of a user following mode, a standby mode, and a driving power support mode based on a position and direction of a user having a terminal module and of operating in the switched mode.

Aspects of the present disclosure are not limited to the above-mentioned features. Other aspects of the present disclosure not mentioned above may be understood from foregoing descriptions and more clearly understood from embodiments of the present disclosure. Further, it will be readily appreciated that the aspects of the present disclosure may be realized by features and combinations thereof as disclosed in the claims.

A main controller of the movable robot to achieve the technical purposes of the present disclosure as described above may detect a position of a user terminal device and may control a driver module having a wheel-rotating motor to operate in a user following mode based on the detected position of the user terminal device to operate. Further, the main controller may control the driving module to operate in a driving-power supporting mode to support manual driving of the robot based on whether a manual driving detector detects the user touch.

Further, the main controller of the mobile robot may control the driver module to operate in the user following mode when the user terminal device is out of the pre-set neutral zone. When the user terminal device is located in the neutral zone, the main controller of the mobile robot may control the driver module to operate in a standby mode. In addition, when a user's touch is detected by a manual driving detector while the user terminal device is located in the neutral zone, the may controller may control the driver module to operate in a driving-power supporting mode to support manual driving of the robot.

Further, the main controller of the mobile robot may compare position coordinate information of the user terminal device with coordinate information of the position detector itself and may check whether the user terminal device is located in one of a plurality of reference regions as preset based on the comparison result, and then may detect current position information about whether the user terminal device is located in front or rear of the position detector or laterally to the robot. When the user terminal device is moved out of the neutral zone while being located in front of the position detector, the main controller of the mobile robot may control the driver module to operate in the user following mode.

In addition, the main controller of the movable robot may control the driver module to operate in the standby mode when the user terminal device is located in the neutral zone while being located laterally to the position detector. Further, when the user terminal device is moved into the neutral zone while being located in rear of the position detector, the main controller of the mobile robot may control the driver module to operate in the driving-power supporting mode to support manual driving of the robot.

Aspects of the present disclosure may be as follows but may not be limited thereto. For example, the movable robot having a shopping cart function according to the present disclosure may provide a transportation service as a shopping cart, and may travel along a user's path in the following mode or may support the driving power in the manual driving mode by the user. Thus, the movable robot having a shopping cart function according to the present disclosure may have increased utilization compared to conventional transportation equipment that provides only a transport service.

Further, the movable robot having a shopping cart function according to the present disclosure may automatically detect in real time whether the user terminal device is within a preset neutral zone and may automatically control the driver module to operate in in one of the user following modes, standby mode, and driving-power supporting mode based on the detection result. Thus, the movable robot having a shopping cart function according to the present disclosure may have expanded fields of applications and improve a quality of service.

Further, the movable robot having a shopping cart function according to the present disclosure may automatically control the driver module to operate in in one of the user following modes, standby mode, and driving-power supporting mode based on the user's position and direction. Thus, the user's convenience and satisfaction may be further improved.

Further, the movable robot having a shopping cart function according to the present disclosure may the function as a shopping cart and may have other loading boxes and luggage packaging members other than a basket in an attached or detached manner. This may allow the utilization of the movable robot as a following cart such as a logistics cart.

Further, the movable robot having a shopping cart function according to the present disclosure may use a low-cost sensor such as UWB (Ultra Wide Band)-based ToF sensor and Lidar sensor to selectively operate the driver module in the following mode, standby mode, and driving-power supporting mode. Thus, a production cost of the movable robot may be lowered.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

It is to be understood that the aforementioned embodiments are illustrative in all respects and not restrictive. Further, the scope of the present disclosure will be indicated by the following claims rather than the aforementioned description. Further, the meaning and scope of the claims to be described later, as well as all changes and modifications derived from the equivalent concept should be construed as being included in the scope of the present disclosure.

What is claimed is:

1. A movable robot comprising:
a frame that constitutes a main body of the robot;
a motor that provides driving force to a wheel rotatably coupled to the frame;
a first sensor that detects a position of a user device;
a second sensor that detects user force applied to the robot by a user; and
a controller that manages the motor such that:
the robot operates in a first mode in which the motor provides driving force to move the robot based on the position of the user device; and
the robot operates in a second mode in which the motor provides driving force to supplement user force detected by the second sensor.

2. The robot of claim 1, wherein the first sensor includes:
a distance sensor to detect a distance between the user device and the robot; and
a camera to capture an image of the user device and to determine a direction of the user device relative to the robot based on the image; and
wherein the controller is further configured to:
generate position coordinate information of the user device based on the distance between the user device and the robot, and the direction of the user device relative to the robot; and
compare position coordinate information of the robot with the position coordinate information of the user device to generate comparison information, the controller further managing the motor to move the robot based on the comparison information when the robot is in the first mode.

3. The robot of claim 1, wherein:
the motor is a first motor, and the robot further comprises a second motor, the first and second motors supplying driving forces, respectively, to first and second wheels rotatably coupled to the frame; and
the controller is further configured to manage the respective driving forces of the first and second motors based on whether user force is detected by the second sensor.

4. The robot of claim 3, wherein the robot further comprises a plurality of the second sensors; and a handle coupled to the frame,
wherein a first one and a second one of the second sensors are positioned on a right portion of the handle and at front and rear faces thereof, respectively,
wherein a third one and a fourth one of the second sensors are positioned on a left portion of the handle and at front and rear faces thereof, respectively.

5. The robot of claim 4, wherein the controller, when managing the respective driving forces of the first and second motors, is further configured to:
when the robot is operating in the second mode, control the respective driving forces of the first and second motors based on whether one or more of the first to fourth ones of the second sensors detect user force; and
when the robot is operating in the first mode, respectively control the driving forces of the first and second motors based on the position of the user device.

6. The robot of claim 1, wherein the controller, when managing the motor, is further to:
compare the position coordinate information of the user device and position coordinate information of the robot to generate movement path information of the user device;
select one of the first mode, the second mode, or a third mode in which the motor does not apply driving force based on comparing the position coordinate information of the user device and the position coordinate information of the robot;
compare the movement path information of the user device with the position coordinate information of the robot when the robot operates in the first mode, and generate a travel coordinate and a travel path of the robot based on comparing the movement path information of the user device with the position coordinate information of the robot; and
manage, when the robot operates in the first mode, the driving force of the motor such that the robot travels while maintaining a particular distance from the user device along the travel coordinate and the travel path.

7. The robot of claim 6, wherein the controller, when selecting one of the first mode, the second mode, or a third mode, is further configured to:
operate the robot in the first mode based on a user selection of the first mode via an input device; and
operate the robot in the second mode to support a manual driving of the robot when the second sensor detects contact of the robot by the user.

8. The robot of claim 7, wherein the controller, when selecting one of the first mode, the second mode, or a third mode, is further configured to:
determine whether the user device is located outside or within a particular neutral zone based on comparing the position coordinate information of the user device and the position coordinate information of the robot; and
when the user device is located outside the neutral zone, operate the robot in the first mode.

9. The robot of claim 8, wherein the controller, when selecting one of the first mode, the second mode, or a third mode, is further configured to:
when the user device is located within the neutral zone, operate the robot in the third mode; and
when contact of the robot by the user is detected by the second sensor while the user device is located within the neutral zone, operate the robot in the second mode to support manual driving of the robot by the user.

10. The robot of claim 7, wherein the controller, when selecting one of the first mode, the second mode, or a third mode, is further configured to:
determine one of a plurality of preset reference regions in which the user device is located based on comparing the position coordinate information of the user device with the position coordinate information of the robot; and
determine whether the user device is position in front or behind the robot or laterally to the robot, based on the one of a plurality of preset reference regions in which the user device is located.

11. A movable robot comprising:
a frame that constitutes a main body of the robot;
a motor that provides a driving force to a wheel rotatably coupled to the frame;
a first sensor that detects a position of a user device of a user;
a second sensor that detects user force applied to the robot by the user; and
a controller configured to:
when the user device is located out of a particular neutral zone, control the robot to operate in a first mode in which the motor provides driving force to move the robot based on the position of the user device;
when user force is detected by the second sensor while the user device is located within the neutral zone, control the robot to operate in a second mode in which the motor provides driving force to supplement the user force to support manual driving of the robot, and
when the user device is located within the neutral zone and user force is not detected by the second sensor, control the robot to operate in a third mode in which the motor does not provide driving force.

12. The robot of claim 11, wherein the controller is further configured to:
receive and compare position coordinate information of the user device and position coordinate information of the robot to generate movement path information of the user device;
select one of the first mode, the second mode, or the third mode further based on comparing the position coordinate information of the user device and the position coordinate information of the robot;
generate, when the robot operates in the first mode, a travel coordinate and a travel path of the robot based on comparing the movement path information of the user device with the position coordinate information of the robot position detector; and
control, when the robot operates in the first mode, the motor such that the robot travels while maintaining a particular distance from the user device along the travel coordinate and the travel path.

13. The robot of claim 12, wherein the controller, when selecting one of the first mode, the second mode, or the third mode, is further configured to:
determine whether the user device is located outside or within the neutral zone based on comparing the position coordinate information of the user device and the position coordinate information of the robot.

14. The robot of claim 12, wherein the controller, when selecting one of the first mode, the second mode, or the third mode, is further configured to:
determine whether the user device is located outside or within the neutral zone based on comparing the position coordinate information of the user device and the position coordinate information of the robot;
when the user device is located within the neutral zone, control the robot to operate in the third mode;
when contact of the robot by the user is detected by the second sensor while the user device is located within the neutral zone, control the robot to operate in the second mode to support the manual driving of the robot; and
when the robot operates in the second mode, control the motor of the driver module to supply the driving force to the wheel, based on user force from the user detected by second sensor.

15. A movable robot comprising:
a frame that constitutes a main body;
a motor that provides a driving force to a wheel rotatably coupled to the frame;
a first sensor that detects a position of a user device of a user;
a second sensor that detects user force applied to the robot by the user; and
a controller that selects one of a first mode, second mode, or a third mode for the robot based on a distance between the robot and the position of the user device and a direction of the position of the user device relative to the robot, the first mode including the motor providing driving force to move the robot based on the position of the user device, the second mode including the motor provides driving force to supplement user force detected by the second sensor, and the third mode including the motor not providing driving force.

16. The robot of claim 15, wherein the controller is further configured to:
compare position coordinate information of the user device and position coordinate information of the robot to generate movement path information of the user device;
select one of the first mode, the second mode, or the third mode based comparing the position coordinate information of the user device and the position coordinate information of the robot;
compare the movement path information of the user device with position coordinate information of the robot when the robot operates in the first mode, and generate a travel coordinate and a travel path of the robot based on comparing the movement path information of the user device with the position coordinate information of the robot; and
control, when the robot operates in the first mode, the motor to provide the diving force such that the robot travels while maintaining a particular distance from the user device along the travel coordinate and the travel path.

17. The robot of claim 16, wherein the controller, when selecting one of the first mode, the second mode, or the third mode, is further configured to:
determine one of a plurality of preset reference regions in which the user device is located based on comparing the position coordinate information of the user device with the position coordinate information of the robot;
determine whether the user device is position in front, behind, or laterally to the robot, based on the determined one of the plurality of preset reference regions in which the user device is located; and
when the user device moves out of a neutral zone while being positioned in front of the robot, control the robot to operate in the first mode.

18. The robot of claim 17, wherein the controller, when selecting one of the first mode, the second mode, or the third mode, is further configured to:
when the user device is located within the neutral zone while positioned laterally to the robot, contact the robot to operate in the third mode; and
when the user device moves into the neutral zone while the user device is positioned behind the robot, control the robot to operate in the second mode.

19. The robot of claim 18, wherein the controller, when selecting one of the first mode, the second mode, or the third mode, is further configured to:
determine whether the user device is located outside or within the neutral zone based on comparing the position coordinate information of the user device and the position coordinate information of the robot; and
when the user device is located outside the neutral zone, automatically control the robot to operate in the first mode.

20. The robot of claim 18, wherein the controller, when selecting one of the first mode, the second mode, or the third mode, is further configured to:
when the user device is located within the neutral zone, control the robot to initially operate in the third mode; and
when user force is detected by the second sensor while the user device is located within the neutral zone, control the driver module to switch from the third mode to the second mode.
